(19) United States
(12) Patent Application Publication
(10) Pub. No.: US 2012/0235315 A1
(43) Pub. Date: Sep. 20, 2012

(54) METHOD FOR FABRICATING A FLEXIBLE DEVICE

(75) Inventors: Chung-Jen Wu, Kaohsiung (TW); Chuan Zong Lee, Kaohsiung (TW); Chih-Min An, Kaohsiung (TW); Yi-Chung Shih, Kaohsiung (TW); Chang-Hong Ho, Kaohsiung (TW)

(73) Assignee: ETERNAL CHEMICAL CO., LTD.

(21) Appl. No.: 13/415,928

(22) Filed: Mar. 9, 2012

(30) Foreign Application Priority Data
Mar. 18, 2011 (TW) 100109490

(51) Int. Cl. B29C 39/12; B29D 7/01

(52) U.S. Cl. 264/104; 264/255

(57) ABSTRACT

A method for fabricating a flexible device is provided, which includes providing a rigid carrier; forming an adhesion layer with a given pattern on the rigid carrier; forming a flexible substrate layer on the rigid carrier, wherein a portion of the flexible substrate layer contacts with the rigid carrier to form a first contact interface and the remaining contacts with the adhesion layer to form a second contact interface; forming at least one device on the surface of the flexible substrate layer opposite to the first contact interface; and separating the flexible substrate from the rigid carrier through the first contact interface.

### BACKGROUND OF THE INVENTION

1. Field of the Invention

The present invention relates to a method for fabricating a flexible device, and in particular to a method for easily separating a device having a flexible substrate from a rigid carrier.

2. Description of the Prior Art

Flat Panel Display (FPD) has currently replaced the conventional Cathode Ray Tube (CRT) and become the mainstream in the market. Known FPDs include, for example, a Liquid Crystal Display (LCD), a Plasma Display Panel (PDP), and an Organic Light Emitting Display (OLED). The FPDs are mostly fabricated after being processed on a rigid substrate (for example, glass). The use of this kind of rigid display is limited due to the lack of flexibility. Therefore, a flexible display with a flexible substrate in place of the traditional glass substrate has become a focus of current research.

The flexible substrates may be classified into three types, including a thin glass substrate, a metal foil substrate, and a plastic substrate. The flexible substrates have different advantages and disadvantages. The fabrication process of a flexible display with a thin glass substrate is similar to that of a rigid FPD produced on a large scale; however, in order to make the substrate flexible, the substrate must be thin enough, thus being fragile and less safe. In addition, the flexibility of the thin glass substrate is not competitive with other flexible substrates. The metal foil substrate has the advantages of high-temperature resistance, high moisture and gas barrier properties, and chemical resistance, but suffers from the disadvantage of being non-transparent, and thus can only be adapted to a particular display device, for example, a reflective display. The plastic substrate is suitable for use in various display devices and may be produced in a roll to roll manner. However, most of the plastic substrates are not resistant to high temperatures, such that the process temperature is limited, and additionally, the coefficient of thermal expansion is high thereby causing the deformation of the substrate easily.

In addition, as the flexible substrate is light and thin, flatness problem easily occurs, so that a device cannot be directly fabricated on a flexible substrate. Therefore, how to successfully arrange a device on a flexible substrate is one of the main critical technologies to be developed at present. One of the methods employed in the industry is to attach a flexible substrate on a rigid carrier, and then strip the flexible substrate from the rigid carrier after the fabrication of the device is completed. Accordingly, how to successfully strip the flexible substrate from the rigid carrier without influencing the quality of the device is a bottle neck of this technology.

FIG. 1 is a schematic view of a conventional method for fabricating a device on a flexible substrate. As shown in FIG. 1(a), a flexible substrate 104 is attached to a rigid carrier 100 by the aid of an adhesion layer 102, and then a device structure, for example, an organic thin film transistor (OTFT), is formed on the flexible substrate. The fabrication process includes, for example, forming a gate electrode 108, a dielectric layer 106, a collector/source electrode 110 and 112, and a channel 114. As shown in FIG. 1(b), after preparing the desired device, the flexible substrate is separated from the rigid carrier; however, due to the adhesion force of the adhesive layer 102, the flexible substrate cannot be easily separated, and residual adhesive tends to be left after separation, thus influencing the quality of the device. In addition, the adhesive layer is generally not resistant to the high temperature, so that the method cannot be used in a process requiring high temperature.

U.S. Pat. No. 7,466,390 further discloses a method for fabricating a flexible display apparatus, which includes providing a substrate arrangement, in which the substrate arrangement includes a rigid glass substrate and an overlying plastic substrate; forming a device on the plastic substrate; and releasing the plastic substrate from the rigid glass substrate through laser irradiation after the device is formed. However, in addition to the complex and time-consuming process, expensive equipment, and high cost, such a technology further has the disadvantages that the laser irradiation must be accurate, and the rigid glass substrate cannot be recycled.

Another method for preparing a flexible electronic device is an indirect transfer technology developed by Seiko Epson Corporation and Sony Corporation, which includes fabricating a device on a rigid carrier, and then transferring the device onto a flexible substrate. However, in the SUFTLA of Seiko Epson Corporation, laser must be accurately controlled, so as to completely strip a Thin Film Transistor (TFT) array from a glass substrate. Sony Corporation uses hydrofluoric acid to remove a glass substrate, and uses a material having a high etch selectivity for hydrofluoric acid as an etch stop layer. When the glass substrate is etched by hydrofluoric acid to the etch stop layer, the etching is stopped, then the etch stop layer is removed, and the device is transferred onto a plastic substrate. In such a technology, the highly toxic hydrofluoric acid must be used, and the device must be protected from being etched by the etching solution during etching. Although the transfer technology is useful in a high-temperature process, disadvantages such as trouble caused to large-scale production due to complex fabrication process also exist in addition to the above disadvantages.

In order to solve the foregoing problems, U.S. Pat. No. 7,575,983 discloses a method for fabricating a device on a flexible substrate. In the method, a “release layer” having no adhesion force is fabricated with a polymer material, and used as an interface layer between a flexible substrate layer and a rigid carrier, which is then immersed in water, so as to strip the flexible substrate through the interface layer. However, since the device is generally required to be protected from water, an additional protective layer is required. Moreover, Taiwan Patent Application No. 98126043 discloses a method for fabricating a substrate structure for use in a flexible device, in which the substrate structure includes a flexible substrate, a release layer, an adhesive material, and a support carrier, and the flexible substrate transferred onto the support carrier will not fall off in the fabrication process, and can be easily separated after all of the processes are completed, by using the properties that the adhesion between the release material and the flexible substrate is poor, and the adhesion between the adhesive material and the flexible substrate is quite good. However, due to the use of the release layer and the adhesive material, the fabrication process is complex, and the production cost is increased, and additionally, the thermal resistance of the release layer or adhesive material used is poor while the fabrication process of the device generally requires operations at a temperature higher than 200° C., thus easily causing unstable quality.

### SUMMARY OF THE INVENTION

In order to solve the above problems, the present invention provides a method for fabricating a flexible device, which includes providing a rigid carrier; forming an adhesion layer with a given pattern on the rigid carrier; forming a flexible substrate layer on the rigid carrier, wherein a portion of the flexible substrate layer contacts with the rigid carrier to form a first contact interface and the remaining contacts with the adhesion layer to form a second contact interface; forming one or more devices on a surface of the flexible substrate layer opposite to the first contact interface; and separating the flexible substrate from the rigid carrier through the first contact interface.

The present invention further provides a method for separating a flexible substrate, particularly a method for separating a flexible substrate from a rigid carrier, which includes providing a rigid carrier; forming an adhesion layer with a given pattern on the rigid carrier; forming a flexible substrate layer on the rigid carrier, wherein a portion of the flexible substrate layer contacts with the rigid carrier to form a first contact interface and the remaining contacts with the adhesion layer to form a second contact interface; and separating the flexible substrate from the rigid carrier through the first contact interface.

The method of the present invention may be conducted by using the existing manufacturing equipments, so as to decrease the cost. In the fabrication process of the device, a flexible substrate can be effectively fixed on a rigid carrier to reduce an alignment deviation resulting from the movement of the flexible substrate in the fabrication process of the device. After the device is fabricated, the flexible substrate can be easily separated from the rigid carrier, without leaving residual adhesive at a bottom surface of the device. Meanwhile, the present invention has three advantages, i.e. resistance to high temperatures, accurate alignment, and easy separation of the flexible substrate.

### BRIEF DESCRIPTION OF THE DRAWINGS

FIG. 1 is a schematic view of a conventional method for fabricating a device on a flexible substrate.

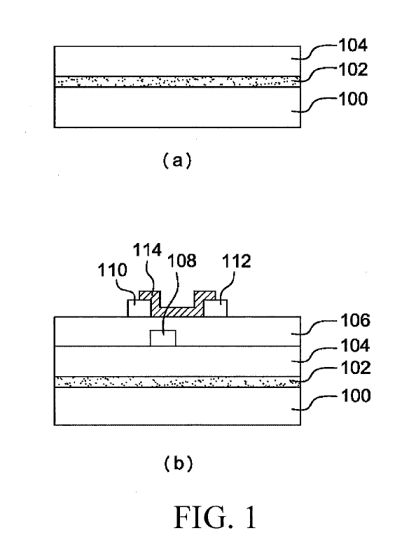

FIGS. 2 to 4 are schematic views of an adhesion layer with a given pattern according to the present invention.

FIG. 5 is a schematic view of an embodiment of a method for fabricating an adhesion layer with a given pattern according to the present invention.

FIG. 6 is a schematic view of an embodiment of a method for fabricating a flexible device according to the present invention.

FIG. 7 is a schematic view showing chemical bonding between an adhesion promoter and a rigid carrier.

FIG. 8 is a schematic view showing chemical bonding between an adhesion promoter and a flexible substrate.

### DETAILED DESCRIPTION OF THE INVENTION

The term “release region” as used herein refers to a region where a flexible substrate is to be separated from a rigid carrier in the method of the present invention.

The term “adhesion region” as used herein refers to a region where a flexible substrate is to contact with a rigid carrier through an adhesion promoting layer in the method of the present invention.

The term “a portion of the flexible substrate layer” as used herein refers to 50% to 99.9%, and preferably 80% to 99.5% of the flexible substrate layer.

The rigid carrier used in the present invention may be any one known to persons of ordinary skill in the art of the present invention, for example, but not limited to, glass, quartz, a wafer, ceramic, a metal, or a metal oxide.

The method of the present invention is mainly characterized by: forming an adhesion layer with a given pattern on a rigid carrier before forming a flexible substrate layer, such that a portion of the flexible substrate layer contacts with the rigid carrier to form a first contact interface and the remaining contacts with the adhesion layer to form a second contact interface. As the adhesion layer contains an adhesion promoter, which can be chemically bonded both to the flexible substrate and the rigid carrier, the flexible substrate layer can be effectively fixed to the rigid carrier even without a binder. In addition, due to the presence of the adhesion promoter, the second contact interface has a strong adherence; and only a trace amount of chemical bonding is present between the flexible substrate and the rigid carrier, and thus the adherence of the first contact interface is less than that of the second contact interface. The flexible substrate can be easily stripped from the rigid carrier through the first contact interface by simply cutting along the edges or periphery of the device after the device is fabricated, such that a process technology conducted on the rigid carrier can be easily transferred to the flexible substrate. In addition, as no release layer or binder that is not resistant to high temperatures exists on the first contact interface between the flexible substrate and the rigid carrier, the method of the present invention is applicable to a device fabrication process requiring high temperature operations.

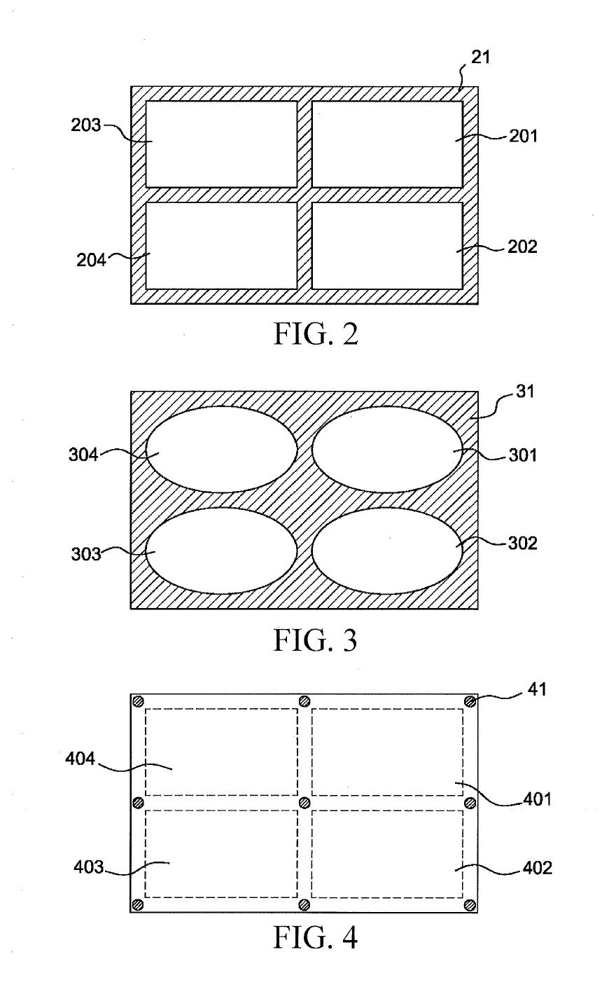

The adhesion layer with the given pattern is not limited to a specific pattern form with respect to the pattern shape, and is distributed peripheral to the release region. For example, the adhesion layer exists in a frame-like form. The shape of the release region is not particularly limited, and may be of, for example, a square shape, a rectangle shape, a rhombus shape, a round shape, or an elliptical shape, and preferably of a square shape or a rectangle shape in consideration of ease of cutting. FIGS. 2, 3, and 4 are respectively embodiments of the adhesion layer. In FIG. 2, release regions are of a rectangle shape (201, 202, 203, and 204), and an adhesion layer 21 is distributed peripheral to the release regions and exists in a frame form surrounding the rectangles. In FIG. 3, release regions are of an elliptical shape (301, 302, 303, and 304), and an adhesion layer 31 is distributed peripheral to the release regions and exists in a frame form surrounding the ellipses. In FIG. 4, release regions are of a rectangle shape (401, 402, 403, and 404), and an adhesion promoting layer 41 is distributed at diagonal positions of the rectangles 401, 402, 403, and 404 as a plurality of points.

The given pattern on the adhesion layer is designed as required by the desired release region. For example, if the final product is a flexible device having a rectangle shape, the shape of the release region to be defined is also a rectangle, and the pattern of the adhesion layer on the rigid carrier may be in a frame form surrounding one or more rectangles. The width of the pattern is not particularly limited, and may be adjusted according to a cutting tool, as long as the operation is simple and the flexible substrate layer can be effectively fixed on the rigid carrier. The width is generally from about 5 to about 1000 micrometers (μm), and may be about 5, about 10, about 30, about 50, about 100, about 300, about 500, or about 700 μm according to the embodiments of the present invention.

The adhesion layer of the present invention is prepared from a composition containing a solvent and an adhesion promoter. The type of the solvent includes, for example, but is not limited to, propylene glycol monomethyl ether (PGME), dipropylene glycol methyl ether (DPM), or propylene glycol monomethyl ether acetate (PGMEA), or a combination thereof, and preferably PGME or PGMEA or a combination thereof. The adhesion promoter may be any one well known to persons of ordinary skill in the art of the present invention, which can be for example, but is not limited to, a silane coupling agent; an aromatic cyclic or heterocyclic compound; a phosphate compound; a multi-valent metal salt or ester, such as titanate or zirconate; an organic polymeric resin, such as epoxy resin or polyester resin; or a chlorinated polyolefin.

The adhesion promoter used in the present invention can be chemically bonded to both the flexible substrate and the rigid carrier, and depending on the types of the rigid carrier and the flexible substrate, an adhesion promoter having a good adhesion force with the rigid carrier and the flexible substrate is selected. For example, when the rigid carrier is a metal substrate, such as gold, silver, or copper, and the flexible substrate is polyimide, an aromatic cyclic or heterocyclic compound having an amino group, such as aminothiophenol, aminotetrazole, or 2-(diphenylphosphino)ethylamine can be selected. When the flexible substrate is polyimide and the rigid carrier is glass, a monomer or a polymer having both an amino group and a lower alkoxy, such as a siloxane monomer having an amino group, a polysiloxane having an amino group, or a combination thereof, preferably the siloxane monomer having an amino group, such as 3-aminopropyl triethoxy silane (APrTEOS), 3-aminopropyl trimethoxy silane (APrTMOS), or a combination thereof can be selected.

Examples of commercially available siloxane monomers having an amino group useful in the present invention include VM-651 and VM-652 (Hitachi DuPont Microsystem Ltd.); AP-3000 (Dow Chemical Company); KBM-903 and KBE-903 (Shin Etsu Co., Ltd.); and AP-8000 (Eternal Chemical Co., Ltd.).

A composition containing a solvent and an adhesion promoter may be applied to the rigid carrier by any method well known to persons of ordinary skill in the art of the present invention, so as to prepare the adhesion layer with the given pattern of the present invention. The method is, for example, but not limited to, a screen printing process, a coating process, a dispensing process, a photolithography process, or a combination thereof.

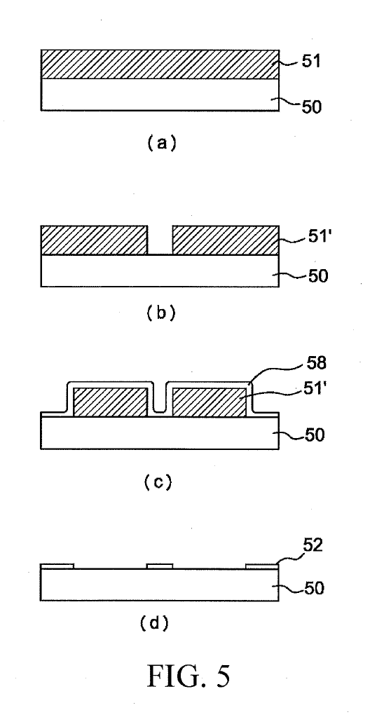

According to an embodiment of the present invention, the adhesion layer with the given pattern is formed on the rigid carrier by a photolithography process, for example, a negative working photoresist process or a positive working photoresist process. FIG. 5 is a schematic view of an embodiment for preparing an adhesion layer with a given pattern by using a photolithography process according to the present invention. As shown in FIG. 5(a), at least one layer of photoresist composition 51 is coated on a glass carrier 50 and then soft baked. The photoresist composition useful in the present invention is not particularly limited, and may contain, for example, a) at least one photocurable monomer or oligomer, or a mixture thereof; b) a polymer binder; c) a photo initiator; and d) an optional thermal curing agent. Various photoresist compositions and preparation methods thereof have been disclosed in many references, such as U.S. patent application Ser. Nos. 11/341,878, 11/477,984, 11/728,500, 10/391,051, 09/040,973, 09/376,539, 09/364,495, and 08/936,305, which are incorporated herein by reference in their entireties. Then, the shape of the release region is defined with a mask, and a lithography process including exposure and development is performed, to leave a protrusion 51′ (FIG. 5(b)) with the shape of the release region on the rigid carrier, in which the related process parameters are readily known by persons skilled in the art. Next, a composition containing a solvent and an adhesion promoter is coated on a glass carrier 50 by spin coating, slot coating or vapor prime, to form a coating 58 (FIG. 5(c)), which is then heated (for example, but not limited to, soft baked for about 5 to about 30 min at a temperature ranging from about 100° C. to about 150° C.), such that the adhesion promoter is chemically bonded to the rigid carrier, and the solvent is removed. If desired, a heating step may be further performed to remove the remaining solvent. Next, the protrusion 51′ and the adhesion promoter at the periphery thereof are removed by using a polar organic solvent, for example, N-methyl-pyrrolidone (NMP), dimethyl sulfoxide (DMSO), propylene glycol monomethyl ether (PGME), acrylonitrile (AN), acetone, or propylene glycol monomethylether acetate (PGMEA), to leave the adhesion layer 52 with a given pattern (FIG. 5(d)).

According to another embodiment of the present invention, the adhesion layer with the given pattern is formed on the rigid carrier by a coating process, for example, a roller coating process. According to a specific embodiment of the present invention, the composition containing the solvent and the adhesion promoter is coated on a glass carrier by a roller coating process, to generate a coating with the given pattern, which is then heated (for example, but not limited to, soft baked for about 5 to about 30 min at a temperature ranging from about 120° C. to about 150° C.), such that the adhesion promoter is chemically bonded to the rigid carrier, and the solvent is removed, thereby the adhesion layer with the given pattern is prepared.

After the solvent is removed, the thickness of the adhesion layer of the present invention is from about 0.5 nanometer (nm) to about 5 μm, and preferably from about 0.7 nm to about 5 nm. The thickness of the adhesion layer is not particularly limited, as long as the adhesion layer functions. However, in order to save material or in view of other considerations such as coefficient of thermal expansion, the thinner the better. According to an embodiment of the present invention, an adhesion layer with a thickness of less than 1 nm can be prepared after soft baking.

The flexible substrate layer of the present invention may be formed on the rigid carrier configured with the adhesion layer by using any method known to persons of ordinary skill in the art of the present invention. For example, a flexible substrate layer is laminated on the rigid carrier, or formed on the rigid carrier by a coating process or a vapor deposition process.

According to an embodiment of the present invention, the flexible substrate layer is formed by using a coating method. The coating method is one well known to persons of ordinary skill in the art of the present invention, for example, slot die coating, micro gravure coating, roller coating, dip coating, spray coating, spin coating, curtain coating, or a combination thereof. For the purpose of obtaining a thin flexible substrate, the slot die coating, the micro gravure coating, or the roller coating is preferably used.

The thickness of the flexible substrate layer is not particularly limited, generally ranges from about 5 μm to about 50 μm and preferably from about 10 μm to about 25 μm, and can be, for example, about 10, about 15, about 20, or about 25 μm according to the embodiments of the present invention.

The flexible substrate useful in the present invention is not particularly limited, and is, for example, a thin glass substrate, a thin metal substrate, or a plastic substrate. The type of the thin metal substrate is, for example, but not limited to, a thin stainless steel metal substrate. According to an embodiment of the present invention, the selected flexible substrate is a plastic substrate, which may be made of any polymer material well known to persons of ordinary skill in the art of the present invention, for example, polyethylene naphthalate (PEN), polyethylene terephthalate (PET), polyethersulfone (PES), polycarbonate (PC), polyacrylate (PA), polysiloxane, polynorbornene (PNB), polyetheretherketone (PEEK), polyetherimide (PEI), or polyimide (PI), or a combination thereof. According to a preferred embodiment of the present invention, the polymer material is polyimide, which is applicable to a high-temperature process of 350° C. or higher.

The preparation of the flexible substrate layer of the present invention is described with polyimide as an example below. A polyimide precursor, i.e., poly(amic acid) is coated on a rigid carrier configured with an adhesion layer, polymerized and cyclized into polyimide. For example, polyimide may be prepared through the following scheme:

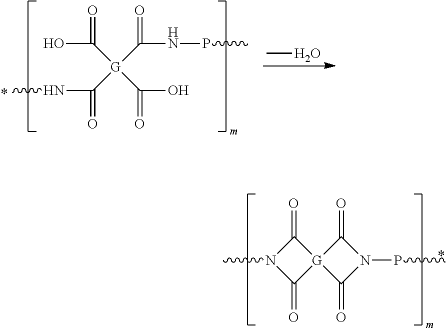

in which G is a tetravalent organic group, P is a divalent organic group, and m is an integer of 0 to 100. Alternatively, polyimide may be prepared with other polyimide precursors or precursor compositions, for example, but not limited to, a polyimide precursor with a formula below:

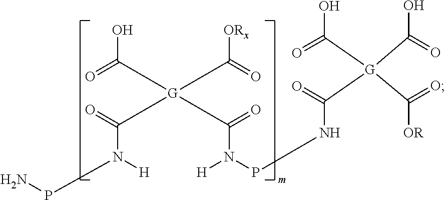

or a polyimide precursor or a precursor composition containing:

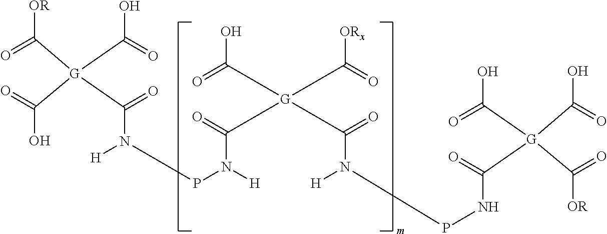

and H₂N—P—NH₂, in which G, P, and m are defined as above, Rx is each independently H or a photosensitive group, and R is an organic group.

Polymerization and cyclization methods of various different polyimide precursors and the polyimides prepared using the same have been developed in the art, for example, those disclosed in U.S. patent application Ser. Nos. 11/785,827, 11/119,555, 12/846,871, and 12/572,398, and Chinese Patent Application Nos. 200610162485.X, and 200710138063.3, which are incorporated herein by reference in their entireties.

According to the method of the present invention, after the flexible substrate layer is formed, a device may be formed on a surface of the flexible substrate layer opposite to the first contact interface. However, the manufacture of the device normally requires high temperatures, such as a temperature of 400° C. or higher for TFT manufacture. To avoid the delamination of the flexible substrate from the rigid carrier due to thermal expansion and contraction, thereby adversely affecting the accurate registration of the formed devise, if desired, a trace amount of chemical bonding exists between the flexible substrate and the rigid carrier at the first contact interface. For example, if the flexible substrate is polyimide and the rigid carrier is glass, the precursor chosen for the polyimide can comprise a trace amount of siloxane groups for forming covalent bonds with the rigid carrier.

The type of the device is not particularly limited, and may be, for example, a semiconductor device, an electronic device, a display device, or a solar energy device, and preferably an electronic device, or a display device. The electronic device is, for example, but not limited to, an OTFT, an amorphous silicon TFT, a low-temperature polysilicon TFT, or a circuit device. The display device is, for example, but not limited to, an LCD, an OLED, a polymer light emitting display (PLED), or an electrophoretic display. The preparation method of the device is well known to persons in the art.

In the method of the present invention, the adhesion layer with the given pattern is used such that a portion of the flexible substrate layer contacts with the rigid carrier to form the first contact interface and the remaining contacts with the adhesion layer to form the second contact interface. In the method of the present invention, due to the absence of the adhesion promoter at the first contact interface between the flexible substrate and the rigid carrier, and thus the adherence of the first contact interface is less than that of the second contact interface. According to an embodiment of the present invention, the adherence of the first contact interface is about 0 B to about 1 B (cross-cut test of adherence, same below), and the adherence of the second contact interface is about 2 B to about 5 B, and preferably about 4 B to about 5 B.

Generally, numerous oxygen or nitrogen atoms with strong negativity exist in the chemical structure of the flexible substrate, which can generate a hydrogen bond with a hydroxyl group on the rigid carrier (for example, glass) such that the flexible substrate is attached to the rigid carrier. However, due to the less strong adherence of the hydrogen bond, an alignment deviation can be easily caused in the fabrication process of the device, and the flexible substrate trends to curl due to the inadequate adherence during cutting, so that the production yield is reduced. According to the method of the present invention, the flexible substrate layer is fixed on the rigid carrier by the aid of the adhesion layer, so as to reduce the alignment deviation caused in the fabrication process of the device, and decrease the defective rate; and as the device is formed on the surface of the flexible substrate layer opposite to the first contact interface, the flexible substrate carrying the desired device can be easily separated from the rigid carrier after the device is fabricated, without leaving residual adhesive at a bottom surface of the device. The separation method is, for example, but not limited to, simply cutting along the edges or periphery of the device, and then stripping the flexible substrate carrying the desired device from the rigid carrier.

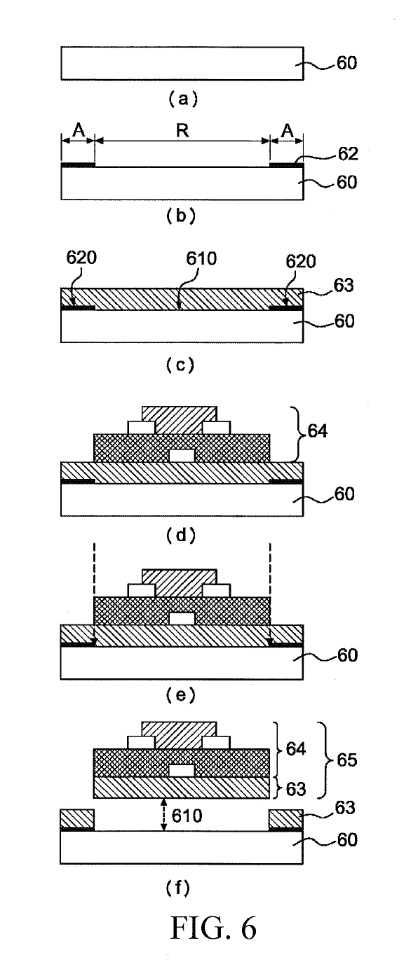

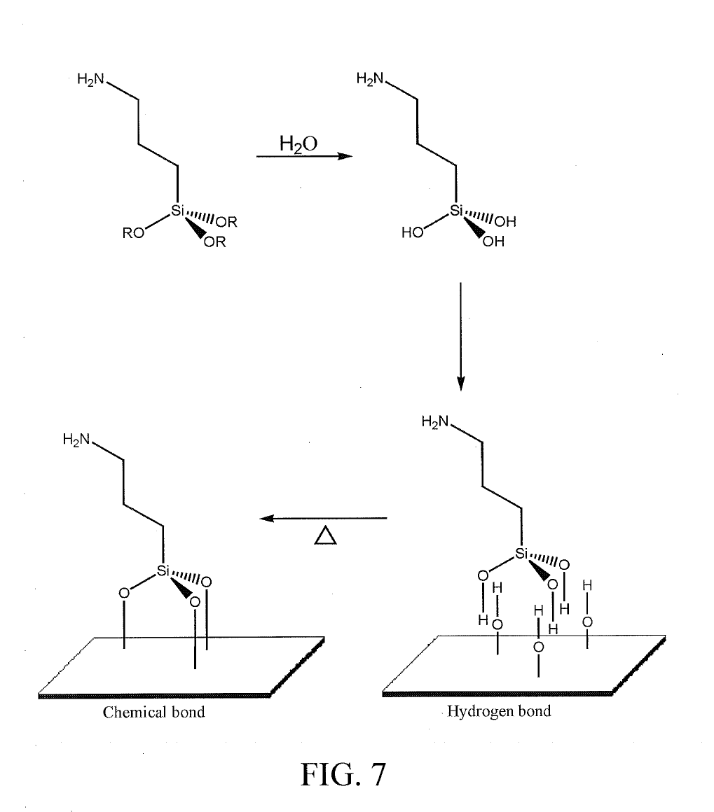

The method for fabricating a flexible device of the present invention is specifically described through an embodiment of the present invention with reference to FIGS. 6 and 7; however, which is provided for illustration purposes only and not intended to make any limitation to the present invention.

First, as shown in FIG. 6(a), a rigid carrier 60 is provided, in which the rigid carrier is glass.

Then, as shown in FIG. 6(b), a composition containing a solvent and an adhesion promoter is coated on the glass carrier 60 by, for example, screen printing or roller coating, to form an adhesion layer 62 with a given pattern, and define a release region R and an adhesion region A at the same time, and is then soft baked (for example, but not limited to, soft baked for about 5 to about 30 min at a temperature ranging from about 100° C. to about 150° C.), and optionally heated to volatilize the solvent in the adhesion layer. As shown in FIG. 7, after coating, an alkoxy group in the adhesion promoter is reduced into a hydroxyl group by reacting with water in air, thereby generating a hydrogen bond with a hydroxyl group (—OH) on the glass carrier 60; and after soft baking, a chemical bond is further generated by a condensation reaction with the hydroxyl group (—OH) on the glass carrier 60. The given pattern is as shown in FIG. 2, 3, or 4, or may be other patterns, and is distributed peripheral to the release region. The solvent may be PGME, PGMEA, or a combination thereof, and preferably PGME. The adhesion promoter may be 3-APrTEOS, 3-APrTMOS, or a combination thereof.

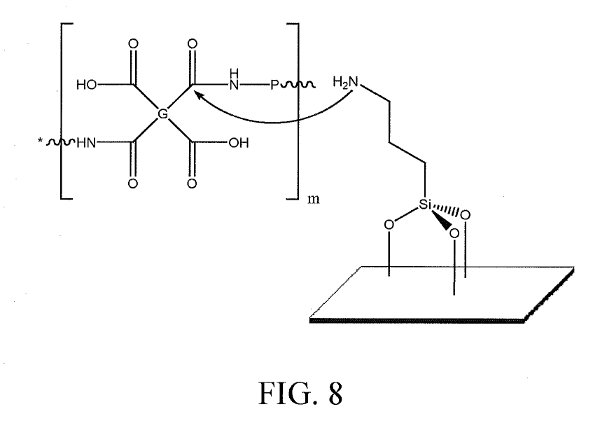

Next, as shown in FIG. 6(c), a flexible substrate layer 63 is formed on the rigid carrier 60. In this example, polyimide is used as the flexible substrate, and a polyimide precursor is coated on the rigid carrier 60 configured with the adhesion layer 62 by slot die coating, and then soft baked (for example, but not limited to, soft baked for about 10 to about 20 min at a temperature ranging from about 80° C. to about 120° C.), such that an amino group (—NH₂) in the adhesion promoter is chemically bonded to the polyimide precursor (as shown in FIG. 8), and then the polyimide precursor is polymerized and cyclized into polyimide, so as to prepare the flexible substrate layer. In FIG. 6(c), a portion of the flexible substrate layer contacts with the rigid carrier 60 to form a first contact interface 610, and the remaining contacts with the adhesion layer to form a second contact interface 620. As the adhesion promoter at the second contact interface is respectively chemically bonded to the flexible substrate and the rigid carrier, while the adhesion promoter does not exist at the first contact interface, the adherence of the first contact interface is less than that of the second contact interface.

After the flexible substrate layer 63 is formed on the rigid carrier 60 in FIG. 6(c), as shown in FIG. 6(d), a device 64 is formed on a surface of the flexible substrate layer 63 opposite to the first contact interface. The type of the device 64 is not particularly limited, and can be, for example, a semiconductor device, an electronic device, a display device, or a solar energy device, and is an electronic device or a display device in this example.

Then, as shown in FIG. 6(e), the flexible substrate layer 63 carrying the desired device is cut along the edges of the device. Afterwards, as shown in FIG. 6(f), the flexible substrate 63 is separated from the rigid carrier 60 through the first contact interface 610, thereby obtaining a flexible device 65. The cutting line in the cutting may lie in a joint portion of the adhesion region A and the release region R (as shown in FIG. 6(f)), or lie in the adhesion region A or the release region R, and preferably lies in the joint portion of the adhesion region A and the release region R. When lying in the adhesion region A, the cutting line preferably lies in the vicinity of the joint portion of the adhesion region A and the release region R, so as to facilitate the separation of the flexible substrate from the rigid carrier. In addition, when lying in the release region R, the cutting line preferably lies in the vicinity of the joint portion of the adhesion region A and the release region R, so as to reduce the curling of the flexible substrate caused by cutting.

According to the method of the present invention, the flexible substrate is effectively adhered onto the rigid carrier by the aid of the adhesion layer with the given pattern, and thus the alignment deviation generated in the fabrication process of the device can be reduced; and as the device is fabricated on a portion of the flexible substrate layer which is not adhered to the rigid carrier by the aid of the adhesion layer, the flexible substrate can be easily separated from the rigid carrier after the device is fabricated. Based on the above technical features, the given pattern of the adhesion promoting layer can be determined depending on the size and shape of the device, and therefore, the method of the present invention is applicable to the fabrication of flexible devices of various sizes.

The present invention has been disclosed above through preferred embodiments, for the purpose of further describing the present invention, rather than limiting the scope of the present invention. Any variations and modifications that can be easily made by persons skilled in the art shall fall within the scope of the disclosure of this specification and the scope of the appended claims.

What is claimed is:

1. A method for fabricating a flexible device, comprising:
providing a rigid carrier;
forming an adhesion layer with a given pattern on the rigid carrier;
forming a flexible substrate layer on the rigid carrier, wherein a portion of the flexible substrate layer contacts with the rigid carrier to form a first contact interface and the remaining contacts with the adhesion layer to form a second contact interface;
forming at least one device on a surface of the flexible substrate layer opposite to the first contact interface; and
separating the flexible substrate from the rigid carrier through the first contact interface.

2. The method according to claim 1, wherein the rigid carrier comprises glass, quartz, a wafer, ceramic, a metal, or a metal oxide.

3. The method according to claim 1, wherein the adhesion layer with the given pattern is prepared from a composition containing a solvent and an adhesion promoter.

4. The method according to claim 3, wherein the adhesion promoter is selected from the group consisting of a silane coupling agent, an aromatic cyclic or heterocyclic compound, a phosphate compound, a multi-valent metal salt or ester, an organic polymer resin, and a chlorinated polyolefin.

5. The method according to claim 3, wherein the solvent is selected from the group consisting of propylene glycol monomethyl ether (PGME), dipropylene glycol methyl ether (DPM), propylene glycol monomethyl ether acetate (PGMEA), and a mixture thereof.

6. The method according to claim 3, wherein the adhesion layer with the given pattern is formed on the rigid carrier by a screen printing process, a coating process, a dispensing process, a photolithography process, or a combination thereof.

7. The method according to claim 1, wherein the flexible substrate is a thin glass substrate, a thin metal substrate, or a plastic substrate.

8. The method according to claim 7, wherein the flexible substrate is a plastic substrate selected from the group consisting of polyethylene naphthalate (PEN), polyethylene terephthalate (PET), polyethersulfone (PES), polycarbonate (PC), polyacrylate (PA), polysiloxane, polynorbornene (PNB), polyetheretherketone (PEEK), polyetherimide (PEI), polyimide (PI), and a mixture thereof.

9. The method according to claim 1, wherein the flexible substrate is polyimide, the rigid carrier is a metal substrate, and the adhesion layer comprises an aromatic cyclic or heterocyclic compound having an amino group as an adhesion promoter.

10. The method according to claim 9, wherein the adhesion promoter is selected from aminothiophenol, aminotetrazole, 2-(diphenylphosphino)ethylamine and a combination thereof.

11. The method according to claim 1, wherein the flexible substrate is polyimide, the rigid carrier is glass, and the adhesion layer comprises an adhesion promoter selected from a siloxane monomer having an amino group, a polysiloxane having an amino group, and a combination thereof.

12. The method according to claim 11, wherein the adhesion promoter is selected from 3-aminopropyl triethoxy silane (APrTEOS), 3-aminopropyl trimethoxy silane (APrTMOS), and a combination thereof.

13. The method according to claim 1, wherein the device is a semiconductor device, an electronic device, a display device, or a solar energy device.

14. A method for separating a flexible substrate from a rigid carrier, comprising:
providing a rigid carrier;
forming an adhesion layer with a given pattern on the rigid carrier;
forming a flexible substrate layer on the rigid carrier, wherein a portion of the flexible substrate layer contacts with the rigid carrier to form a first contact interface and the remaining contacts with the adhesion layer to form a second contact interface; and
separating the flexible substrate from the rigid carrier through the first contact interface.
